(19) United States
(12) Patent Application Publication
(10) Pub. No.: US 2006/0275565 A1
(43) Pub. Date: Dec. 7, 2006

(54) Autoblock valve for non latex type baloons

(76) Inventor: Jose De Jesus Michel Velasco, Tlajomulco (MX)

Correspondence Address: MALACARA & ASSOCIATES, 82 CHAPEL HILL CIRCLE, SAN ANTONIO, TX, 78240, US

(21) Appl. No.: 11/143,815

(22) Filed: Jun. 3, 2005

(51) Int. Cl. B32B 27/32; A63H 3/06

(52) U.S. Cl. 428/35.2; 446/224

(57) ABSTRACT

The present invention is referred to an auto block valve applied to non-latex type balloons, manufactured from a single piece of rectangular plastic sheet folded in halve, sealed in between, such seal possess a special and characteristic form that hinders the extraction of the air or gas, it also counts in the gas or air entrance, channel and exit with lacquer or thermo resisting ink capable of resisting capable of inhibiting in a partial or total manner the force of the seal avoiding that the entrance, channel and exit is closed or obstructed at the moment of assembly of the valve with the balloon.

### INVENTION TECHNICAL FIELD

The present invention is referred to an auto block valve for non latex balloons, the invention is aimed at the field of industry that utilizes entrance, channel and exit air valves or helium gas, more specifically to those applied to balloons of the non latex type and to any kind of apparatus that may require a device of the above mentioned characteristics.

### PRIOR ART

Within the technical area of valves utilized on inflatable objects there are different types of valves that vary in size, form and disposition of their components, however they are al configured in the same way that is to say; they are composed of three parts: entrance, channel or passage and air or gas exit.

The non latex balloon or inflatable package is not the exception, it also requires such device, this is to say, the valve must carry the following functions: inflation or air entrance, channel or passage, exit and blocking or retention of air or gas, more yet there are devices in existence that offer an additional function, that of the deflation or extraction of the air or gas.

The non-latex balloon or inflatable package is not the exception, it also requires of a device it is to say the valve must be able to perform the following tasks: inflation or air entry, channel or passage, exit and blocking o retention of the air or gas, further more, there are devices in existence that offer an additional function, that of deflation of gas or air.

Within the field of non latex type balloons the pumping method is utilized for them to be filled with air or helium gas sealing them with a fastener, strings utilizing heat or vapor to seal the material that these devises are made of with the finality of preventing the escape of gas or air throughout the longest possible time period and thus lengthening that time that the air or gas stays within the balloon, these are systems that trough time have become obsolete and inefficient to achieve that objective.

Auto-block valves that cover the function of not letting air or gas escape from the balloon exist, and they require the application of two plastic material sheets stuck together by heating them trough vapor uniting them, this causes that such valves in a short time span permit the escape of air or gas. These valves have already been patented under the following patent Numbers. U.S. Pat. Nos. 510,833, 5,169,353, 5,188,588, 5,259,805, 5,338,243, 589,448, 6,076,758, 6,575,805, 5,248,275, 5,378,299, 5,482,492, 5,514,022, 5,595,521, 5,733,406, 5,779,614, 5,797,783, 5,806,165, D414,222 and D415,841.

The invention being dealt with is manufactured from a single piece of rectangular plastic sheet folded exactly by half, so that there is no balloon fixation tongue, sealed within, the seal has a special form that gives it the characteristic of impeding the exit of gas or air and it also counts in the area that comprises the entrance, the channel and the exit of air or gas with lacquer or thermo resistant ink capable of inhibiting in a total or partial manner the strength of the glue, avoiding that the entrance, channel or passage and exit of air or gas is closed or obstructed at the moment of the realization of the assembly of the valve with the balloon operation that is done simultaneously.

### OBJECTIVE OF THE INVENTION

The present invention has as its objective the creation of an auto-block valve constituted of a single flexible material piece with which the user can be able to eliminate or diminish the air or gas loss applied to non latex type balloons, without using strings, brooches or vapor to avoid the prompt leak of gas or air in non-latex type balloons, lengthening with so the time span of duration of the latter, hereby letting the consumer enjoy the product for a longer period of time.

### BRIEF DESCRIPTION OF THE INVENTION

The device that my invention propones is composed of and auto-block valve manufactured from a single piece of rectangular plastic sheet folded exactly by half and sealed, such seal possesses a special form and characteristic that prevents air from being extracted, it counts also in the area that comprises the entrance, channel, and exit with lacquer or thermo resistant ink capable of inhibiting in a partial or total manner the strength of the glue or seal avoiding that the entrance, channel passage or exit are blocked at the moment of assembling the valve with the balloon operation that is done in one single time lapse. The valve will stay trapped and contained completely within both of the layers flexible plastic sheet that will conform the balloon, while the external faces will be fixed or sealed to the internal faces of the flexible material, leaving one part fixed to the valve's pivot while the rest will stay within the inflatable chamber of the balloon.

### DESCRIPTION OF THE DRAWINGS

FIG. 1. Is a view in perspective of a latex type balloon in which both layers of plastic sheet (e) that conform it can be appreciated indicating the positioning of the valve.

FIG. 2. Is a frontal view in which it can be appreciated the form in which the valve is positioned (f).

FIG. 3. Is a transversal cut of the valve in which it can be observed the air or gas exit directly in the interior of the balloon (c)

FIG. 4. Is a transversal cut of the valve in which it can be observed in which it can be noted the air or gas exit at the interior of the balloon trough a orifice (c).

FIG. 5. Is a transversal cut of the valve in which it can be observed the air exit at the interior of the balloon trough an arc (c).

FIG. 6. Is a view in perspective of the valve in an arc type in which it can be noted that the rectangular sheet of which it is manufactured is folded in halve. FIGS. 3(d) 4(d) y 5 (d). Where it can be appreciated the pressed part (d) where lacquer or ink is not applied so they can be perfectly sealed where the lines are conforming in such way the valve.

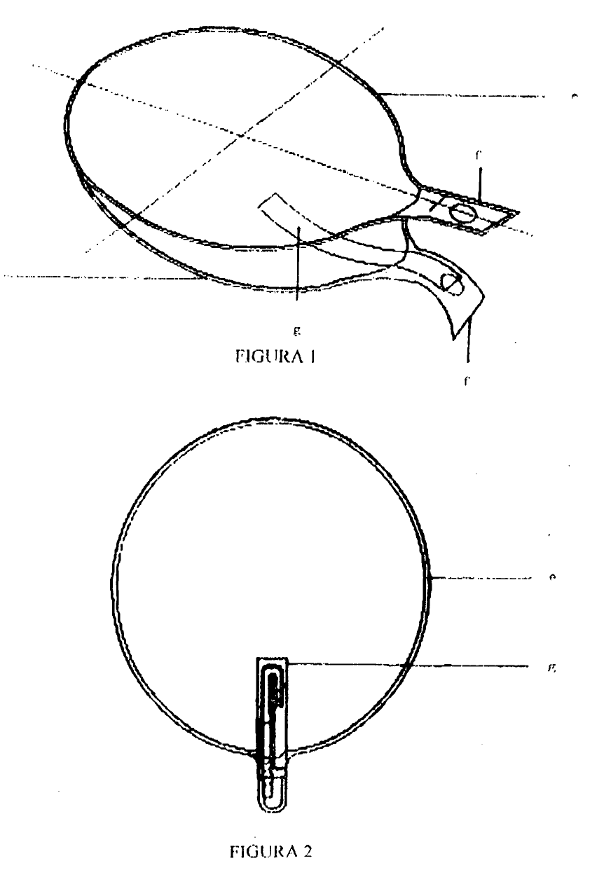

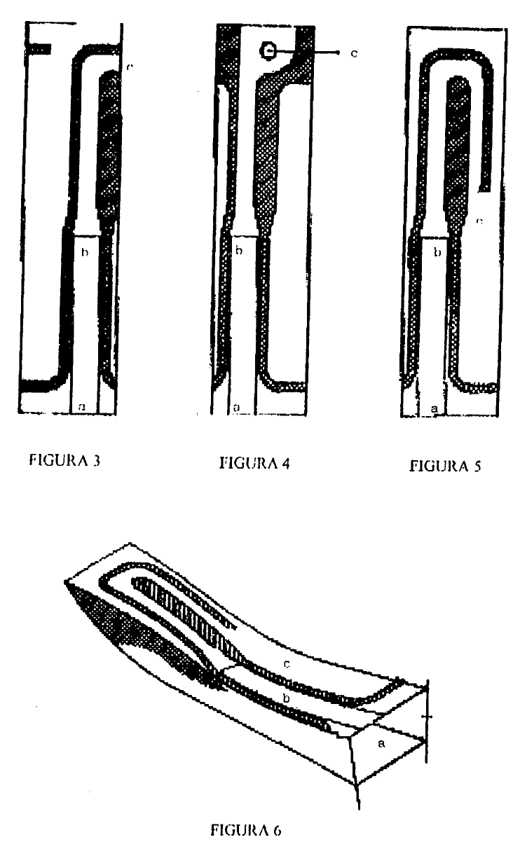

### DETAILED DESCRIPTION OF THE INVENTION

The valve that is described has being designed to solve the problematic that balloons presently involve balloons, which when being inflated with a valve that permits the deflation of the later, at the same time it permits that the air or gas escapes in a spontaneous manner, so that with the invention to protect the user will find a new alternative to obtain a valve with the necessary characteristics to avoid the leak of air or gas utilized in non latex type balloons giving them a long inflation period to the later.

The invention that is described is constituted from one same piece o low density polyethylene piece and of a caliber close to 50 microns in a rectangular form, the sheet is folded exactly by halve in such way that it does not overlap, as it can be appreciated in FIG. 6, once folded it is sealed with a thermal press, which will seal (d) the sheet leaving the necessary spaces for the entrance (a) channel (b) and exit (c) of the air or gas, giving as a result the conformation of the parts that constitute the valve, this being, entrance (a), channel or passage (b) and exit (c) of the air or gas, which will be able to have any of the forms that are represented in FIGS. 3,4 and 5. This Operation is done using one of the three valve forms described previously, accommodating it accordingly between the two layer that will make up the balloon (e), by means of the thermo press that has embossed the valve figures chosen and the perimeter from of the balloon (e) sealing the folded film perfectly to make the valve together with the two layers that will conform the balloon.

This simultaneous valve and balloon sealing process must be done using lacquer or ink leaving without being glued or sealing the areas destined for the entrance (a), channel (b), exit (c) and the space for gas or air inside the balloon.

In the view of FIG. 2 the positioning of the valve inside the balloon can be observed (g), the inferior part that constitutes the halve of the valve stays united and trapped in the pivot zone (f) increasing its rigidity, and in consequence diminishing the possibility of micro leaks of air or gas while the superior part (g) stays floating freely inside the inflatable chamber in the balloon body where the internal pressure that the air or gas exerts into the internal part of the balloon provokes that the valve is flexed or rolled facilitating the blocking function of the valve preventing with it the exit of the air or gas to the exterior of the balloon.

Having described complacently mi invention, I consider it novel and so I claim as of my exclusive property what is contained in the following clauses:

1. Auto-block valve for non latex type balloons, those that are constituted of an exact folding by halve of a rectangular sheet characterized for being constituted at least of two sealed lines (d) hermetically with a press to form entrance (a), channel (b) and exit (c) of the air or gas that will flow to the interior of the balloon.

2. A valve for balloons of the non-latex kind, and according to the preceding clauses characterized because of the spaces of air passage or gas can make up different forms that are appreciated in FIGS. 3,4 and 5, which will be given by the hermetically sealed lines (d).

3. A method to manufacture the auto-block valve for non-latex type balloons characterized by the following stages.
I. Folding exactly by halve a low density and approximately 50 micron plastic sheet of rectangular form so that the walls be formed using the press that has embossed the lines that will seal (d) hermetically forming the different forms (FIGS. 3,4 and 5)
II. Sealing hermetically with a press, giving special forms that can be appreciated in FIGS. 3,4 and 5, using lacquer or ink that has for objective not to permit that the walls are sealed in the area where the ink or lacquer is applied an in such way the stay well glued the lines marked by the embossed high relief that the press has drawn in one of its faces an so the entrance (a), channel (b) and exit (c) of air or gas that will flow into the interior of the balloon are formed.
